(19) United States
(12) Patent Application Publication
(10) Pub. No.: US 2005/0254349 A1
(43) Pub. Date: Nov. 17, 2005

(54) Day and time chronometer movement

(76) Inventor: John P. Kallestad, Incline Village, NV (US)

Correspondence Address: Brian C. Kelly, Ltd.;Attorney at Law, 555 South Center St., Reno, NV, 89501, US

(21) Appl. No.: 10/789,388

(22) Filed: Feb. 28, 2004

(51) Int. Cl. G04B 19/26

(52) U.S. Cl. 368/28

(57) ABSTRACT

A clock comprising means for actuating a hand to indicate day of the week.

### FIELD OF THE INVENTION

This invention relates generally to the field of chronometers.

### BACKGROUND OF THE INVENTION

The prior art includes numerous clocks for telling time, but there has not been a hand movement for indicating the day of the week. The Applicant's invention overcomes the problems of the prior art.

### BRIEF DESCRIPTION OF THE DRAWINGS

FIG. 1 is a top view of the device;

FIG. 2 is an end view of the device;

FIG. 3 is a bottom view of the device;

FIG. 4 is a sectional view of the device;

FIG. 5 is a sectional view of the device;

FIG. 6 is a sectional view of the device;

FIG. 7 is a sectional view of the device;

FIG. 8 is a sectional view of the device;

FIG. 9 is a sectional view of the device;

FIG. 10 is a side sectional view of the device; and

FIG. 11 shows a clock face.

### DETAILED DESCRIPTION OF THE PREFERRED EMBODIMENT

FIG. 1 shows a top view of a housing which has a separate wheel for adjusting the time 1 and one for adjusting the day 2. The housing holds a battery 9 as the power source for the movement within the battery door 10. The invention contemplates a mechanical movement as well. The invention contemplates a quartz based movement.

FIG. 2 shows a side view of the movement detailing the drive post 3 for driving the clock hands 11.

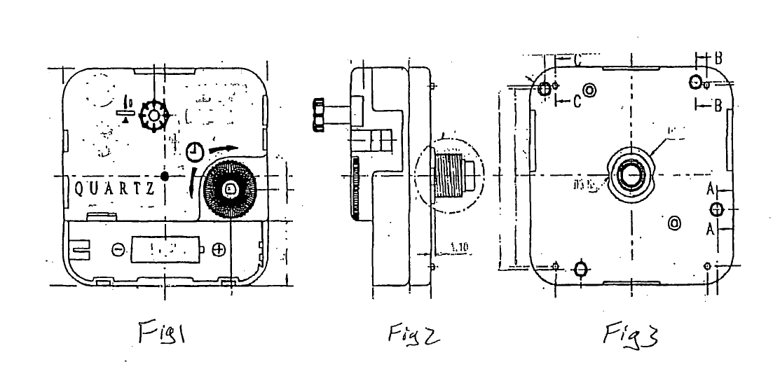

FIG. 3 shows a bottom view of the invention with the post to drive the day hand 11 on the outside; the post to drive the hour hand 12 in the middle and the post to drive the minute hand 13 on the inside of both the other posts.

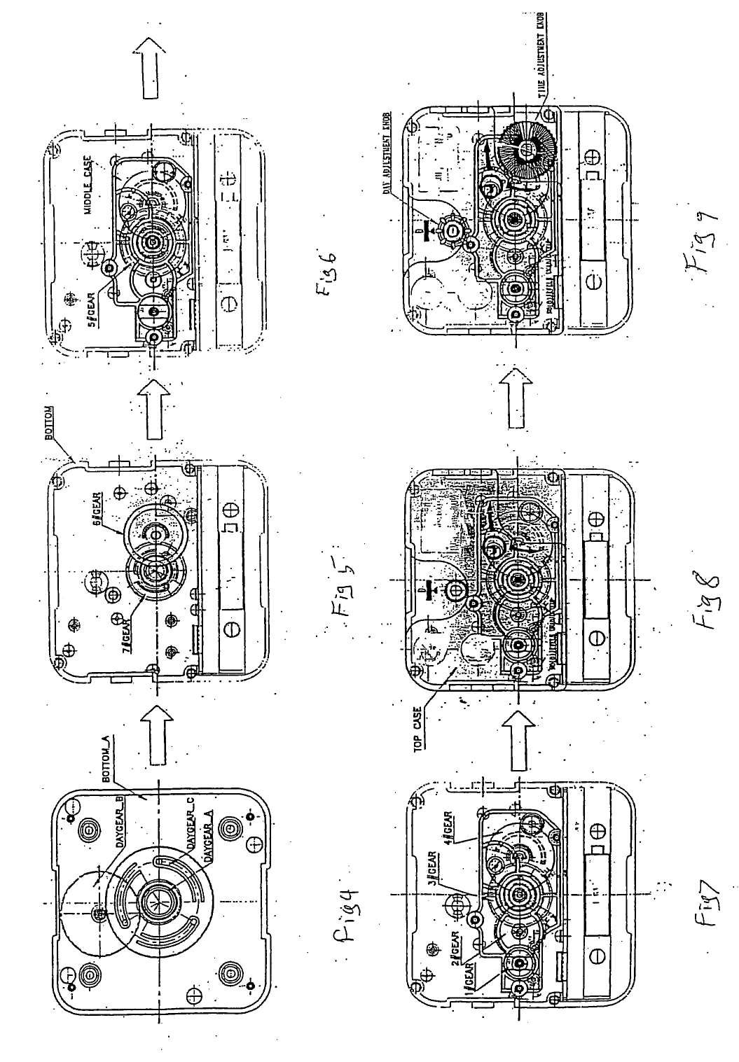

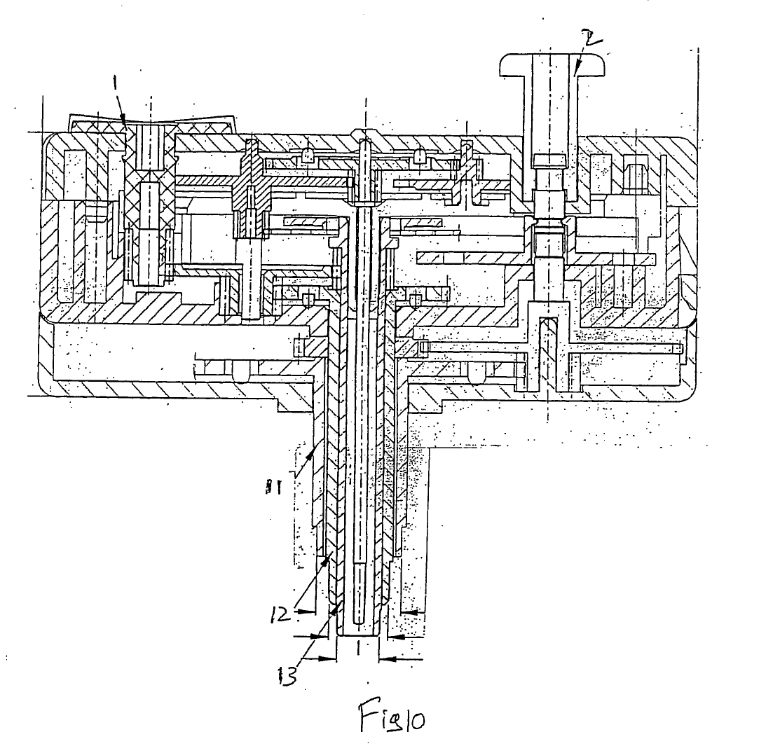

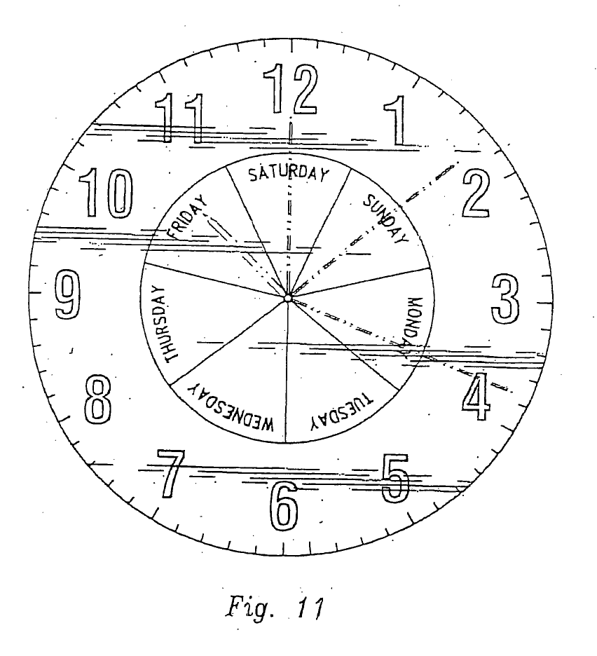

FIGS. 4-9 show progressive slices of the case from the bottom to the top. FIG. 4 highlights the day gear C which provides one revolution to day gear A for each 14 rotations of the hour hand. Day gear B manually adjusts the day position from the wheel 2. FIG. 5 shows how gears 6 and 7 translate the rotation of the time movement to the day gears, and the location of the battery 9. FIG. 6 highlights gear 5 which is the hour gear which also engages gear 7. FIG. 7 shows gears 1-4. Gear 1 is driven by the quartz drive and work through gears 2 and 3 to drive the minute and hour hands. Gear 4 translates manual movement of wheel 1 to the time hands.

FIG. 10 shows a side sectional view of the drive. The drive has 3 concentric shafts for driving the hands. The outer shaft 11 is for the day hand, the middle shaft 12 is for the hour hand, and the center shaft 13 is for the minute hand. The Applicant's invention has provided a means for driving a day indicating clock with rotating hands.

FIG. 11 shows a clock face with the hands for day, hour, and minute.

Obviously, numerous (additional) modifications and variations of the present invention are possible in light of the above teachings. It is, therefore, to be understood that the invention may be practiced otherwise than as specifically described herein and is limited only by the claims below.

1. A clock comprising means for actuating a hand to indicate day of the week.

2. A clock as described in claim 1 wherein said means for actuating said hand comprises at least one gear having a rotation cycle of 7 days.

3. A clock as described in claim 2 wherein said gear communicates with at least one other gear that completes 14 revolutions in said cycle.

4. A clock as described in claim 3 wherein said other gear actuates at least one hand to indicate hours.

5. A clock as described in claim 1 wherein said means comprises quartz oscillation.

6. A clock as described in claim 1 wherein said means comprises battery power means.

7. A clock as described in claim 1 further comprising means for adjusting time indicated by said clock.

8. A clock as described in claim 1 wherein said adjustment means comprises at least one knob.

9. A clock as described in claim 1 wherein said adjustment means comprises at least one knob to adjust said day indicator.
